(19) United States
(12) Patent Application Publication
(10) Pub. No.: US 2025/0053239 A1
(43) Pub. Date: Feb. 13, 2025

(54) PSEUDO HAPTIC SENSE PRESENTATION DEVICE, PSEUDO HAPTIC SENSE PRESENTATION METHOD, AND PROGRAM

(71) Applicant: NIPPON TELEGRAPH AND TELEPHONE CORPORATION, Tokyo (JP)

(72) Inventors: Yusuke UJITOKO, Tokyo (JP); Takahiro KAWABE, Tokyo (JP)

(73) Assignee: NIPPON TELEGRAPH AND TELEPHONE CORPORATION, Tokyo (JP)

(21) Appl. No.: 18/719,910

(22) PCT Filed: Dec. 23, 2021
(86) PCT No.: PCT/JP2021/047987

§ 371 Date: Jun. 14, 2024

(51) Int. Cl. G06F 3/01; G06F 3/0481

(52) U.S. Cl. CPC G06F 3/016; G06F 3/0481

(57) ABSTRACT

A pseudo-haptic sensation presentation device receives first designation information that designates a specific user interface used for presenting a pseudo-haptic sensation, obtains, by using correspondence information indicating a correspondence between a plurality of pieces of registered user interface information indicating a plurality of different registered user interfaces and a plurality of pieces of conformity information for specifying visual information that is presented from the registered user interfaces in order to present the pseudo-haptic sensation, specific conformity information that is conformity information corresponding to the registered user interface information indicating the specific user interface designated by the first designation information, and, based on the specific conformity information, obtains output information indicating visual information that is presented from the specific user interface.

### TECHNICAL FIELD

The present invention relates to a technique for causing a human to perceive a pseudo-haptic sensation by presenting output information corresponding to input information.

### BACKGROUND ART

There is known a technique of presenting, from an output device such as a display (monitor) or a touchscreen, visual information corresponding to input information input to an input device such as a mouse, a keyboard, or a gesture sensor, thereby causing a human to perceive a pseudo-haptic sensation (e.g. see Non Patent Literature 1). By using the technique, it is possible to achieve an application that causes a human to perceive a desired pseudo-haptic sensation.

### CITATION LIST

### Non Patent Literature

Non Patent Literature 1: Y. Ujitoko and Y. Ban, “Survey of Pseudo-haptics: Haptic Feedback Design and Application Proposals,” in IEEE Transactions on Haptics, doi: 10.1109/TOH. 2021.3077619. [Searched on Dec. 19, 2021], Internet <https://ieeexplore.ieee.org/document/9424469>

### SUMMARY OF INVENTION

### Technical Problem

However, input information, which is necessary to cause a human to perceive a desired pseudo-haptic sensation, and visual information presented in response to the input information depend on the type of user interface such as an input device or an output device. This makes it necessary to design an application one by one for each user interface, and thus an application design load is high. Not limited to this, it is convenient if a desired pseudo-haptic sensation can be perceived by using any user interface.

The present invention has been made in view of such a point, and an object thereof is to provide a technique capable of causing a human to perceive a desired pseudo-haptic sensation by using any user interface among a plurality of registered user interfaces (hereinafter, “registered user interfaces”).

### Solution to Problem

A pseudo-haptic sensation presentation device receives first designation information that designates a specific user interface used for presenting a pseudo-haptic sensation, obtains, by using correspondence information indicating a correspondence between a plurality of pieces of registered user interface information indicating a plurality of different registered user interfaces and a plurality of pieces of conformity information for specifying visual information that is presented from the registered user interfaces in order to present the pseudo-haptic sensation, specific conformity information that is conformity information corresponding to the registered user interface information indicating the specific user interface designated by the first designation information, and, based on the specific conformity information, obtains output information indicating visual information that is presented from the specific user interface.

### Advantageous Effects of Invention

Therefore, it is possible to cause a human to perceive a desired pseudo-haptic sensation by using any user interface among a plurality of registered user interfaces.

### BRIEF DESCRIPTION OF DRAWINGS

FIG. 1 is a block diagram showing a configuration of a pseudo-haptic sensation presentation device according to an embodiment.

FIG. 2 shows correspondence information.

FIG. 3 shows conformity information.

FIGS. 4A and 4B show an interface (IF) disclosed in an application programming interface (API) unit.

FIG. 5 shows correspondence information.

FIG. 6 shows correspondence information.

FIG. 7 shows correspondence information.

FIG. 8 is a block diagram showing a hardware configuration of a pseudo-haptic sensation presentation device.

### DESCRIPTION OF EMBODIMENTS

Hereinafter, embodiments of the present invention will be described with reference to the drawings.

### First Embodiment

First, a first embodiment of the present invention will be described.

### <Configuration>

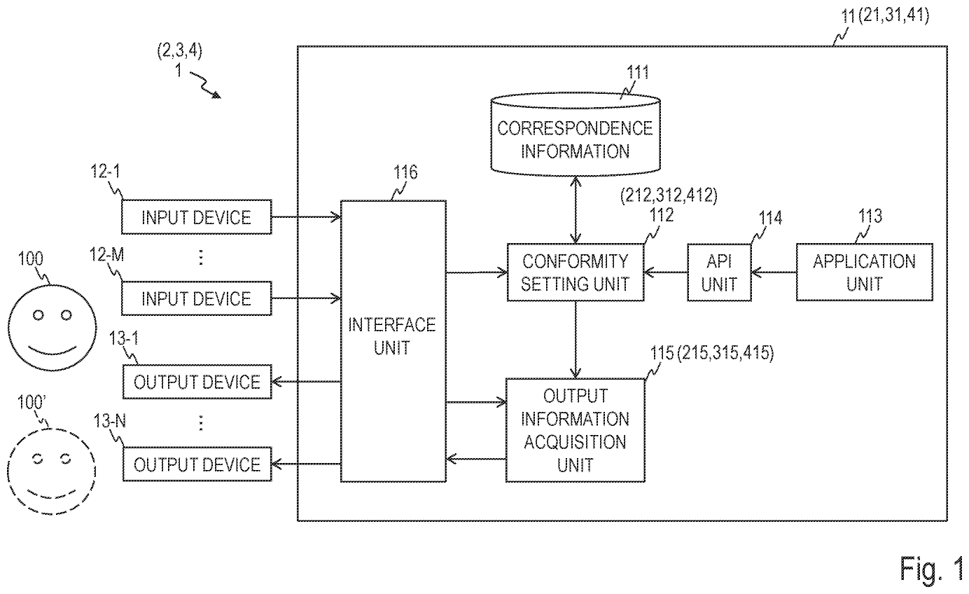

As shown in FIG. 1, a pseudo-haptic sensation presentation system 1 of the present embodiment includes a pseudo-haptic sensation presentation device 11 for presenting a pseudo-haptic sensation based on visual information and input devices 12-1 to 12-M and output devices 13-1 to 13-N which are user interfaces for presenting the pseudo-haptic sensation based on the visual information. Here, M and N are integers of 1 or more. For example, at least one of the input devices 12-1 to 12-M and the output devices 13-1 to 13-N is plural, and M+N is an integer of 3 or more.

The pseudo-haptic sensation presentation device 11 includes a storage unit 111, a conformity setting unit 112, an application unit 113, an API unit 114, an output information acquisition unit 115, and an interface unit 116. A hardware configuration of the pseudo-haptic sensation presentation device 11 will be described below.

The input devices 12-1 to 12-M receive input of information. For example, in a case where M is 2 or more, the input devices 12-1 to 12-M receive different types of information. For example, the input devices 12-1 to 12-M are a button-type input device such as a mouse, a keyboard, or a button, a touchpad or touchscreen with a touch sensor, and a non-contact input device such as a gesture sensor. However, the present invention is not limited thereto.

The output devices 13-1 to 13-N present (e.g. output or display) visual information. For example, the output devices 13-1 to 13-N are a monitor or touchscreen that outputs visual information to a screen, a virtual reality headset that presents visual information in a virtual space, a projector that projects visual information, and a real object such as a robot arm that presents visual information in a real space to a user 100 through deformation or trajectory of the robot arm. However, the present invention is not limited thereto.

### <Preprocessing>

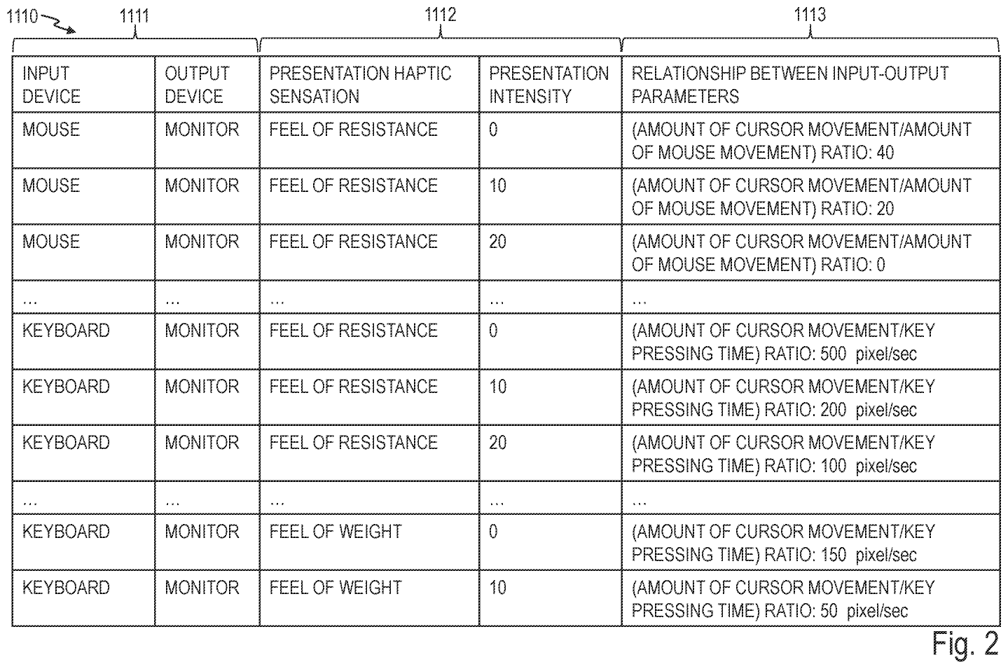

As preprocessing, correspondence information 1110 is stored in the storage unit 111. As shown in FIG. 2, the correspondence information 1110 of the present embodiment indicates a correspondence (relationship) among a plurality of pieces of registered user interface information 1111 (a plurality of pieces of registered user interface information, each of which indicates both the input devices and the output devices) which indicates the input devices 12-1 to 12-M and the output devices 13-1 to 13-N (a plurality of different registered user interfaces; a plurality of registered user interfaces including both the input devices and the output devices), a plurality of pieces of pseudo-haptic sensation information 1112 indicating presentation haptic sensations and presentation intensities of different pseudo-haptic sensations (contents of different pseudo-haptic sensations), and a plurality of pieces of conformity information 1113 for specifying visual information that is presented from the output devices 13-1 to 13-N in response to information input to the input devices 12-1 to 12-M in order to present a pseudo-haptic sensation (visual information that is presented from the registered user interfaces in order to present the pseudo-haptic sensation having the content indicated by the pseudo-haptic sensation information).

The registered user interface information 1111 in FIG. 2 indicates the input devices 12-1 to 12-M such as a mouse, a keyboard, a button, a touchpad, a touchscreen, and a gesture sensor and the output devices 13-1 to 13-N such as a monitor, a touchscreen, a virtual reality headset, a projector, and a robot arm.

The presentation haptic sensation of the pseudo-haptic sensation information 1112 in FIG. 2 indicates a type of pseudo-haptic sensation to be presented. For example, the presentation haptic sensation may be a haptic attribute of a texture such as a feel of resistance, a feel of weight, a feel of softness (feel of hardness), a feel of friction, a feel of roughness, and a feel of unevenness (e.g. see Non Patent Literature 1), may be a feel of material, or may be a perceived force (e.g. a reaction force when pressing an object, a tractive force pulled from an object, or a remotely acting magnetic force).

The presentation intensity of the pseudo-haptic sensation information 1112 in FIG. 2 indicates the degree (e.g. size or intensity) of the pseudo-haptic sensation to be perceived. An example of the presentation intensity is an integer score of 0 to 100. For example, a higher score may indicate a greater pseudo-haptic sensation to be perceived, the score 0 indicates that “no pseudo-haptic sensation is perceived”, and the score 100 indicates that “the greatest pseudo-haptic sensation imaginable is perceived”. The presentation intensity may be a value of five stages or seven stages. A physical quantity equivalent to the pseudo-haptic sensation to be perceived may be defined by a psychophysical experiment, and the physical quantity may be used as the presentation intensity. The presentation intensity may be expressed by using a standardized or de facto standardized index. For example, the presentation intensity may be expressed by a grit size of sandpaper. The presentation intensity may also be a ratio (magnification) of an index indicating the degree of the pseudo-haptic sensation to some reference. For example, when the grit size “#40” of sandpaper is used as the reference (presentation intensity of 1), a ratio of the grit size of the sandpaper indicating the degree of the pseudo-haptic sensation to be perceived to the reference may be used as the presentation intensity. The presentation intensity may also be expressed in a natural language. The degree of the pseudo-haptic sensation that is roughness may be expressed as “rough”, “smooth”, or the like or may be expressed as “not feel rough at all”, “feel slightly rough”, or the like.

The conformity information 1113 may be any information as long as the conformity information specifies visual information (e.g. visual information indicated by output parameters) which is presented from the output devices 13-1 to 13-N in response to information (e.g. input parameters) which is input to the input devices 12-1 to 12-M in order to present a pseudo-haptic sensation. For example, the conformity information 1113 may indicate a relationship between input-output parameters, which is a relationship between the input parameters and the output parameters indicating the visual information. For example, the conformity information 1113 may indicate a ratio between the degree of information input to the input devices 12-1 to 12-M (e.g. input parameters such as an amount of movement and an operation time) and the degree of visual information presented from the output devices 13-1 to 13-N (e.g. output parameters such as an amount of movement, a moving speed, an amount of change, a change rate, and a vibration frequency). For example, in a case where the input device is a mouse, the degree of information input by using the mouse is an amount of mouse movement, the output device is a monitor, and the degree of visual information presented therefrom is an amount of cursor movement, the conformity information 1113 may be a ratio of the amount of cursor movement to the amount of mouse movement (amount of cursor movement/amount of mouse movement). For example, in a case where the input device is a keyboard, the degree of information input by using the keyboard is a key pressing time, the output device is a monitor, and the degree of visual information presented therefrom is an amount of cursor movement, the conformity information 1113 may be a ratio of the amount of cursor movement to the key pressing time (amount of cursor movement/key pressing time). For example, the visual information may be not a cursor but another object (e.g. video), and the degree of visual information to be presented may be an amount of movement, a moving speed, or a vibration frequency of the object. For example, the degree of visual information to be presented may not be an amount of movement, a moving speed, or a vibration frequency of a cursor or object, but may be an amount of change in size or change rate of another object or an amount of change (amount of transition) in saturation or luminance thereof. For example, the input device may be a gesture sensor, the degree of information input by the gesture sensor may be an amount of movement of a body part, the output device may be a monitor, and the degree of visual information presented therefrom may be the amount of change in size of the object or the amount of change in saturation or luminance thereof. For example, the conformity information 1113 may be a ratio of the amount of change in size of the object to the amount of movement of the body part (amount of change in size of object/amount of movement of body part). For example, the visual information to be presented may be complicatedly changed. For example, an object, which is a video to be presented as the visual information, may be deformed to be recessed in a depth direction of a screen, or a pattern on a surface of the object may be deformed or moved (e.g. traveled or rotated). In such a case, the conformity information 1113 may be a ratio of a moving speed of the pattern to the amount of movement of the mouse or body part input by using the input device (moving speed of pattern/amount of movement). The output device may be a real object such as a robot arm, and the degree of visual information presented therefrom may be an amount of movement of the real object. In such a case, the conformity information 1113 may be a ratio of the amount of movement of the real object to the amount of movement of the mouse or body part input by using the input device (amount of movement of real object/amount of movement of mouse or body part). The degree of information input by using the input device may be an input time, the degree of visual information presented from the output device may be a presentation time, and a delay (time difference) between the input time and the presentation time may be the conformity information 1113. Further, the conformity information 1113 may also be combinations of the ratios and the delay described above. However, the present invention is not limited thereto.

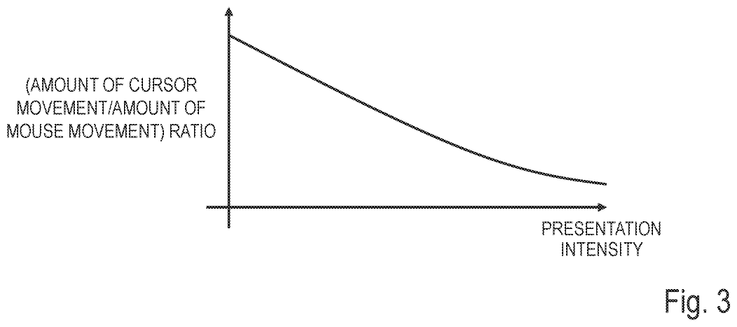

In the correspondence information 1110 in FIG. 2, the registered user interface information 1111, the pseudo-haptic sensation information 1112, and the conformity information 1113 are associated with each other. For example, the correspondence information 1110 in FIG. 2 is a table in which the registered user interface information 1111 and the pseudo-haptic sensation information 1112 are used as keys to obtain the conformity information 1113 corresponding to the registered user interface information 1111 and the pseudo-haptic sensation information 1112. However, the present invention is also not limited thereto, and at least part of the correspondence information 1110 may be indicated by a function (mathematical model). For example, a relationship among at least part of the registered user interface information 1111 (input devices 12-1 to 12-M and/or output devices 13-1 to 13-N), at least part of the pseudo-haptic sensation information 1112 (presentation haptic sensation and/or presentation intensity), and the conformity information 1113 may be expressed as a function (not shown), a relationship between at least part of the registered user interface information 1111 and the conformity information 1113 may be expressed as a function (not shown), or a relationship between at least part of the pseudo-haptic sensation information 1112 and the conformity information 1113 may be expressed as a function (not shown). For example, a function that returns the conformity information 1113 when receiving input of the registered user interface information 1111 and the pseudo-haptic sensation information 1112 may be stored in the storage unit 111 as the correspondence information 1110. For example, a function that returns the conformity information 1113 when receiving input of the pseudo-haptic sensation information 1112 may be set for each piece of the registered user interface information 1111. Only some records of the correspondence information 1110 may be shown by functions, or all records may be shown by functions. FIG. 3 shows a function that returns an (amount of cursor movement/amount of mouse movement) ratio of the conformity information 1113 when receiving input of the presentation intensity of the pseudo-haptic sensation information 1112. For example, such a function is associated with a record in which the input device of the registered user interface information 1111 is a mouse, the output device is a monitor, and the presentation haptic sensation of the pseudo-haptic sensation information 1112 is a feel of resistance. However, the present invention is not limited thereto.

### <Pseudo-Haptic Sensation Presentation Processing>

The following pseudo-haptic sensation presentation processing is performed on the premise of the above preprocessing, thereby presenting a pseudo-haptic sensation to the user 100.

The interface unit 116 (first input unit) receives designation information SUI (first designation information) which designates an input device 12-m (specific input device) and an output device 13-n (specific output device) used for presenting a pseudo-haptic sensation (specific user interfaces including both the specific input device and the specific output device) among the input devices 12-1 to 12-M and the output devices 13-1 to 13-N. Here, m∈{1, . . . , M} and n∈{1, . . . , N} are satisfied. The designation information SUI may be information (e.g. automatically detected information) indicating any input device 12-m and output device 13-n connected to the interface unit 116 or may be information input by any of the input devices 12-1 to 12-M connected to the interface unit 116. The designation information SUI input to the interface unit 116 is transmitted to the conformity setting unit 112 (step S116).

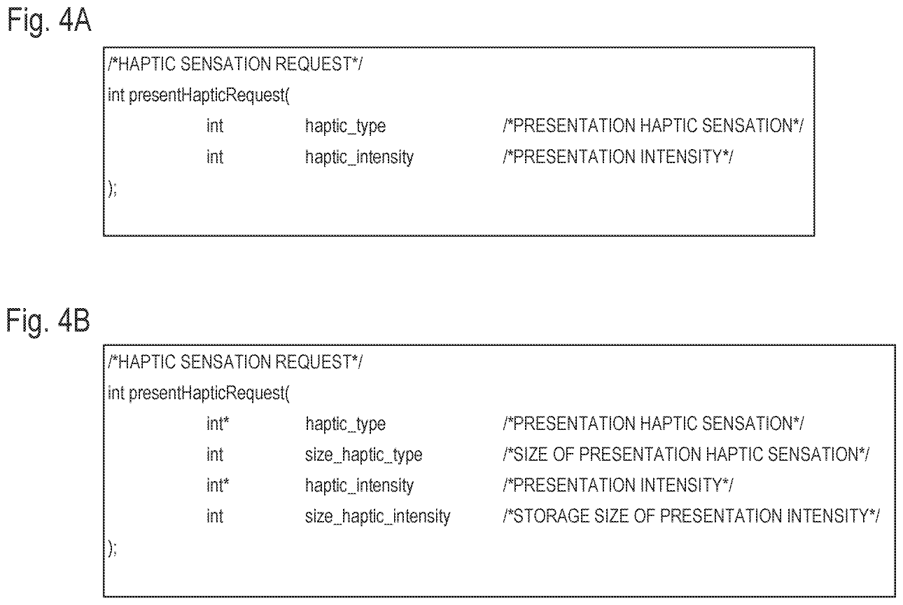

The application unit 113 outputs a haptic sensation presentation request for presenting a desired pseudo-haptic sensation to the user 100. The haptic sensation presentation request includes designation information SSH (second designation information) which designates a content of a pseudo-haptic sensation to be presented (e.g. at least one of the presentation haptic sensation and the presentation intensity of the pseudo-haptic sensation). The designation information SSH may designate a content of a single pseudo-haptic sensation or may designate content of a plurality of pseudo-haptic sensations. The haptic sensation presentation request including the designation information SSH is transmitted to the API unit 114. That is, the API unit 114 (second input unit) receives the haptic sensation presentation request including the designation information SSH (second designation information) which designates the content of the pseudo-haptic sensation to be presented. The API unit 114 transmits the haptic sensation presentation request to the conformity setting unit 112. For example, the conformity setting unit 112 discloses a predetermined interface (IF) to the application unit 113, and the application unit 113 receives the haptic sensation presentation request including the designation information SSH via the IF. FIG. 4A shows an IF for transmitting the presentation haptic sensation and the presentation intensity. In a case where the designation information SSH designates contents of a plurality of pseudo-haptic sensations, as shown in FIG. 4B, an IF for transmitting a plurality of presentation haptic sensations and presentation intensities and a storage size of an array thereof may be used. Note that the application unit 113 may be implemented in any manner. For example, the application unit 113 may be implemented as a web application accessed through a web browser or may be implemented as an embedded system in the pseudo-haptic sensation presentation device 11 (step S113).

The conformity setting unit 112 receives input of the designation information SUI transmitted in step S116 and the haptic sensation presentation request including the designation information SSH transmitted in step S113. The conformity setting unit 112 uses the correspondence information 1110 stored in the storage unit 111 to obtain specific conformity information that is the conformity information 1113 corresponding to the registered user interface information 1111 indicating the specific user interfaces (input device 12-m and output device 13-n) designated by the designation information SUI (first designation information) and the pseudo-haptic sensation information 1112 indicating the pseudo-haptic sensation having the content (presentation haptic sensation and presentation intensity) designated by the designation information SSH (second designation information). For example, the conformity setting unit 112 searches the correspondence information 1110 by using the designation information SUI and the designation information SSH as keys, thereby obtaining specific conformity information that is a record of the conformity information 1113 associated with a record of the registered user interface information 1111 indicating the input device and the output device designated by the designation information SUI and a record of the pseudo-haptic sensation information 1112 indicating the pseudo-haptic sensation having the presentation haptic sensation and presentation intensity designated by the designation information SSH. The specific conformity information is transmitted to the output information acquisition unit 115 (step S112).

The user 100 inputs input information for presenting a pseudo-haptic sensation (information input to the input device in order to present a pseudo-haptic sensation) to the input device 12-m used for presenting a pseudo-haptic sensation. The input device 12-m receives the input information and transmits the input information to the interface unit 116. The interface unit 116 transmits the input information to the output information acquisition unit 115. The input information and the specific conformity information transmitted in step S112 are input to the output information acquisition unit 115. Based on the specific conformity information, the output information acquisition unit 115 obtains and outputs output information indicating visual information that is presented from the output device 13-n (specific user interface; specific output device) in response to the input information. The output information indicates visual information that is presented from the output device 13-n (specific output device) in response to the information input to the input device 12-m (specific input device). For example, based on a relationship between input-output parameters indicated by the specific conformity information, the output information acquisition unit 115 obtains and outputs, as output information, output parameters (e.g. amount of movement, moving speed, amount of change, change rate, and vibration frequency) indicating the visual information presented from the output device 13-n, the output parameters corresponding to input parameters (e.g. amount of movement and operation time) based on the information input to the input device 12-m. The output information is input to the interface unit 116, and the interface unit 116 outputs the output information to the output device 13-n used for presenting a pseudo-haptic sensation. The output device 13-n presents the visual information (e.g. video or motion of real object) based on the output information. Therefore, the user 100 perceives a pseudo-haptic sensation requested by the haptic sensation presentation request presented from the application unit 113 (step S115).

As described above, the pseudo-haptic sensation presentation device 11 of the present embodiment receives the first designation information (designation information SUI) which designates specific user interfaces (input device 12-m and output device 13-n) used for presenting a pseudo-haptic sensation, obtains, by using the correspondence information 1110 indicating a correspondence between the plurality of pieces of the registered user interface information 1111 indicating a plurality of different registered user interfaces (input devices 12-1 to 12-M and output devices 13-1 to 13-N) and the plurality of pieces of the conformity information 1113 for specifying visual information presented from the registered user interfaces in order to present the pseudo-haptic sensation, specific conformity information that is the conformity information 1113 corresponding to the registered user interface information 1111 indicating the specific user interface designated by the first designation information (designation information SUI), and, based on the specific conformity information, obtains output information indicating visual information that is presented from the specific user interface (output device 13-n). Therefore, it is possible to cause a human to perceive a desired pseudo-haptic sensation by using any user interface among the plurality of registered user interfaces (input devices 12-1 to 12-M and output devices 13-1 to 13-N).

In the present embodiment, the plurality of registered user interfaces includes both input devices (input devices 12-1 to 12-M) and output devices (output devices 13-1 to 13-N), the plurality of pieces of the registered user interface information 1111 indicates both the input devices (input devices 12-1 to 12-M) and the output devices (output devices 13-1 to 13-N), the plurality of pieces of the conformity information 1113 specifies visual information that is presented from the output devices (output devices 13-1 to 13-N) in response to information input to the input devices (input devices 12-1 to 12-M) in order to present a pseudo-haptic sensation, the specific user interface designated by the first designation information (designation information SUI) includes both the specific input device (input device 12-m) and the specific output device (output device 13-n), and the output information presented from the output information acquisition unit 115 indicates visual information that is presented from the specific output device (output device 13-n) in response to information input to the specific input device (input device 12-m).

From the above, any combination of the specific input device (input device 12-m) and the specific output device (output device 13-n) can present a desired pseudo-haptic sensation. This eliminates the necessity to consider an input device and output device used for presenting a pseudo-haptic sensation in design of the application unit 113. The application unit 113 only needs to transmit a haptic sensation presentation request via the API unit 114. Therefore, for example, even if the input device and output device used for presenting a pseudo-haptic sensation are replaced, it is unnecessary to change the application unit 113.

### First Modification Example of First Embodiment

The first embodiment shows an example where the registered user interfaces include both the input devices (input devices 12-1 to 12-M) and the output devices (output devices 13-1 to 13-N), and the registered user interface information 1111 indicates both the input devices (input devices 12-1 to 12-M) and the output devices (output devices 13-1 to 13-N) (FIG. 2). However, in a case where the input devices are fixed (e.g. are fixed to the input device 12-1), the input devices may be omitted from the registered user interfaces, and information indicating the input devices may be omitted from the registered user interface information 1111. That is, the registered user interfaces may include only the output devices (output devices 13-1 to 13-N), and the registered user interface information 1111 may indicate only the output devices (output devices 13-1 to 13-N). Similarly, in a case where the output devices are fixed (e.g. output device 13-1), the output devices may be omitted from the registered user interfaces, and information indicating the output devices may be omitted from the registered user interface information 1111. That is, the registered user interfaces may include only the input devices (input devices 12-1 to 12-M), and the registered user interface information 1111 may indicate only the input devices (input devices 12-1 to 12-M). That is, the plurality of registered user interfaces may include at least one of the input devices (input devices 12-1 to 12-M) and the output devices (output devices 13-1 to 13-N), the plurality of pieces of the registered user interface information 1111 may indicate at least one of the input devices (input devices 12-1 to 12-M) and the output devices (output devices 13-1 to 13-N), the plurality of pieces of the conformity information 1113 may specify visual information that is presented from the output devices in response to information input to the input devices in order to present a pseudo-haptic sensation, the specific user interface designated by the first designation information (designation information SUI) may include at least one of the specific input device (input device 12-m) and the specific output device (output device 13-n), and the output information output from the output information acquisition unit 115 may indicate visual information that is presented from the specific output device (output device 13-n) in response to information input to the specific input device (input device 12-m). The other aspects are the same as those of the first embodiment.

### Modification Example 2 of First Embodiment

In the first embodiment, the correspondence information 1110 includes the plurality of pieces of the pseudo-haptic sensation information 1112 indicating contents of different pseudo-haptic sensations (FIG. 2). However, in a case where the content of the pseudo-haptic sensation to be presented is fixed, the correspondence information 1110 may not include the pseudo-haptic sensation information 1112. In this case, the haptic sensation presentation request output from the application unit 113 may not include the designation information SSH (second designation information). In this case, the conformity setting unit 112 only needs to obtain specific conformity information that is the conformity information 1113 corresponding to the registered user interface information 1111 indicating the specific user interface (input device 12-m and output device 13-n) designated by the designation information SUI (first designation information) by using the correspondence information 1110 stored in the storage unit 111. The other aspects are the same as those of the first embodiment.

### Second Embodiment

A plurality of output devices may be used in combination to present a pseudo-haptic sensation. Hereinafter, an example where two output devices are used in combination will be described for simplification of description. However, the present invention is not limited thereto, and three or more output devices may be used in combination. Hereinafter, differences from the first embodiment will be mainly described below, and the same reference signs will be used for the matters that have already been described to simplify the description.

### <Configuration>

As shown in FIG. 1, a pseudo-haptic sensation presentation system 2 of the present embodiment includes a pseudo-haptic sensation presentation device 21 for presenting a pseudo-haptic sensation based on visual information and the input devices 12-1 to 12-M and the output devices 13-1 to 13-N which are user interfaces for presenting the pseudo-haptic sensation based on the visual information. Here, in the present embodiment, M is an integer of 2 or more, and N is an integer of 1 or more. In the present embodiment, all the output devices 13-1 to 13-N may present visual information, or only some of the output devices 13-1 to 13-N may present visual information, and the other output devices may present haptic information such as vibration, force, or heat, may present auditory information, may present olfactory information, or may present taste information. The pseudo-haptic sensation presentation device 21 includes the storage unit 111, a conformity setting unit 212, the application unit 113, the API unit 114, an output information acquisition unit 215, and the interface unit 116. A hardware configuration of the pseudo-haptic sensation presentation device 21 will be described below.

### <Preprocessing>

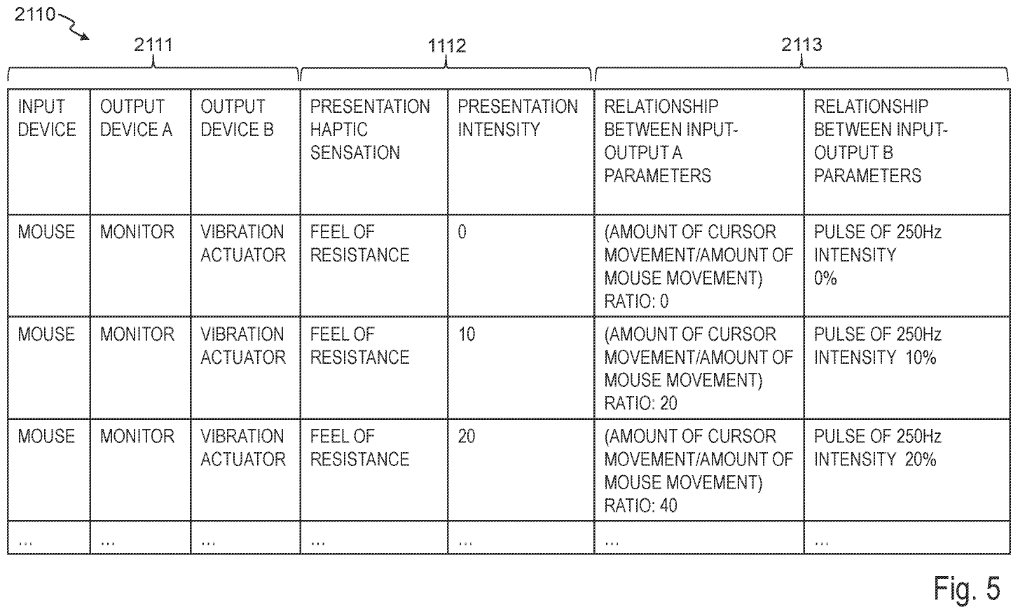

As preprocessing, correspondence information 2110 is stored in the storage unit 111. As shown in FIG. 5, the correspondence information 2110 of the present embodiment indicates a correspondence (relationship) among a plurality of pieces of registered user interface information 2111 indicating the input devices 12-1 to 12-M and the output devices 13-1 to 13-N (a plurality of different registered user interfaces; a plurality of registered user interfaces including both the input devices and the output devices), a plurality of pieces of the pseudo-haptic sensation information 1112 indicating presentation haptic sensations and presentation intensities of different pseudo-haptic sensations (contents of different pseudo-haptic sensations), and a plurality of pieces of conformity information 2113 for specifying visual information that is presented from the output devices 13-1 to 13-N in response to information input to the input devices 12-1 to 12-M in order to present a pseudo-haptic sensation (visual information that is presented from the registered user interfaces in order to present the pseudo-haptic sensation having the content indicated by the pseudo-haptic sensation information).

The correspondence information 2110 of the present embodiment is different from the correspondence information 1110 of the first embodiment in the following points. A first difference is that the correspondence information 2110 of the present embodiment includes, instead of the registered user interface information 1111, the registered user interface information 2111 that is a combination including information indicating the input devices 12-1 to 12-M (input devices), information indicating a first registered output device (output device A) that presents first type visual information among the output devices 13-1 to 13-N, and information indicating a second registered output device (output device B) that presents second type information different from the first type visual information among the output devices 13-1 to 13-N. That is, the specific user interfaces of the present embodiment include a first specific output device that presents the first type visual information and a second specific output device that presents the second type information different from the first type visual information. The second type information may be visual information, haptic information, auditory information, olfactory information, or taste information. The registered user interface information 2111 in FIG. 5 is a combination including the input devices 12-1 to 12-M (input devices, for example, mouses), the first registered output device (output device A, for example, monitor) which presents the first type visual information, and the second registered output device (output device B, for example, vibration actuator) which presents the second type information.

A second difference is that the correspondence information 2110 of the present embodiment includes, instead of the conformity information 1113, a plurality of pieces of conformity information 2113 for specifying the first type visual information and the second type information that are presented from the first registered output device (output device A, for example, monitor) and the second registered output device (output device B, for example, vibration actuator) in order to present a pseudo-haptic sensation. For example, the conformity information 2113 specifies visual information that is presented from the first registered output device (output device A, for example, monitor) in response to information (e.g. input parameters) input to the input devices 12-1 to 12-M in order to present a pseudo-haptic sensation and information that is presented from the second registered output device (output device B, for example, vibration actuator) in response to the information (e.g. input parameters) input to the input devices 12-1 to 12-M. For example, as shown in FIG. 5, the conformity information 2113 may indicate a relationship between input-output A parameters, which is a relationship between the input parameters input to the input devices 12-1 to 12-M and the output parameters indicating the visual information presented from the first registered output device (output device A, for example, monitor), and a relationship between input-output B parameters, which is a relationship between the input parameters input to the input devices 12-1 to 12-M and the output parameters indicating the information presented from the second registered output device (output device B, for example, vibration actuator). The other aspects are as described above in the first embodiment.

### <Pseudo-Haptic Sensation Presentation Processing>

The following pseudo-haptic sensation presentation processing is performed on the premise of the above preprocessing, thereby presenting a pseudo-haptic sensation to the user 100.

The interface unit 116 (first input unit) receives the designation information SUI (first designation information) which designates, as the specific user interfaces used for presenting a pseudo-haptic sensation, the input device 12-m (specific input device) included in the input devices 12-1 to 12-M and an output device 13-n₁ (first specific output device) which presents the first type visual information and an output device 13-n₂ (second specific output device) which presents the second type information different from the first type visual information among the output devices 13-1 to 13-N. That is, the specific user interfaces of the present embodiment include a first specific output device that presents the first type visual information and a second specific output device that presents the second type information different from the first type visual information. Here, m∈{1, . . . , M}, n₁∈{1, . . . , N}, n₂∈{1, . . . , N}, and n₁≠n₂ are satisfied. The designation information SUI may be information (e.g. automatically detected information) indicating any input device 12-m and output devices 13-n₁ and 13-n₂ connected to the interface unit 116 or may be information input by any of the input devices 12-1 to 12-M connected to the interface unit 116. The designation information SUI input to the interface unit 116 is transmitted to the conformity setting unit 212 (step S216).

As described in the first embodiment, the application unit 113 outputs a haptic sensation presentation request including the designation information SSH. The haptic sensation presentation request including the designation information SSH is transmitted to the API unit 114. The API unit 114 transmits the haptic sensation presentation request to the conformity setting unit 212 (step S213).

The conformity setting unit 212 receives input of the designation information SUI transmitted in step S216 and the haptic sensation presentation request including the designation information SSH transmitted in step S213. The conformity setting unit 212 uses the correspondence information 2110 stored in the storage unit 111 to obtain specific conformity information that is the conformity information 2113 corresponding to the registered user interface information 2111 indicating the specific user interfaces (input device 12-m and output devices 13-n₁ and 13-n₂) designated by the designation information SUI (first designation information) and the pseudo-haptic sensation information 1112 indicating the pseudo-haptic sensation having the content (presentation haptic sensation and presentation intensity) designated by the designation information SSH (second designation information). The specific conformity information is transmitted to the output information acquisition unit 215 (step S212).

The user 100 inputs input information for presenting a pseudo-haptic sensation (information input to the input device in order to present a pseudo-haptic sensation) to the input device 12-m used for presenting a pseudo-haptic sensation. The input device 12-m receives the input information and transmits the input information to the interface unit 116. The interface unit 116 transmits the input information to the output information acquisition unit 215. The input information and the specific conformity information transmitted in step S212 are input to the output information acquisition unit 215. Based on the specific conformity information, the output information acquisition unit 215 obtains and outputs first output information indicating the first type visual information that is presented from the output device 13-n₁ (first specific output device) in response to the input information and second output information indicating the second type information that is presented from the output device 13-n₂ (second specific output device) in response thereto. The first output information is input to the interface unit 116, and the interface unit 116 outputs the first output information to the output device 13-n₁ used for presenting a pseudo-haptic sensation. The second output information is input to the interface unit 116, and the interface unit 116 outputs the second output information to the output device 13-n₂ used for presenting a pseudo-haptic sensation. The output device 13-n₁ presents the first type visual information (e.g. video or motion of real object) based on the first output information. The output device 13-n₂ presents the second type information based on the second output information. Therefore, the user 100 perceives a pseudo-haptic sensation requested by the haptic sensation presentation request presented from the application unit 113 (step S215).

### First Modification Example of Second Embodiment

In a case where the input devices are fixed in the second embodiment as well as in the first modification example of the first embodiment, the input devices may be omitted from the registered user interfaces, and information indicating the input devices may be omitted from the registered user interface information 2111.

### Second Modification Example of Second Embodiment

In a case where the content of the pseudo-haptic sensation to be presented is fixed in the second embodiment as well as in the first modification example of the first embodiment, the correspondence information 2110 may not include the pseudo-haptic sensation information 1112.

### Third Embodiment

A plurality of input devices may be used in combination to present a pseudo-haptic sensation. Hereinafter, an example where two input devices are used in combination will be described for simplification of description. However, the present invention is not limited thereto, and three or more input devices may be used in combination.

### <Configuration>

As shown in FIG. 1, a pseudo-haptic sensation presentation system 3 of the present embodiment includes a pseudo-haptic sensation presentation device 31 for presenting a pseudo-haptic sensation based on visual information and the input devices 12-1 to 12-M and the output devices 13-1 to 13-N which are user interfaces for presenting the pseudo-haptic sensation based on the visual information. Here, in the present embodiment, M is an integer of 1 or more, and N is an integer of 2 or more. The pseudo-haptic sensation presentation device 31 includes the storage unit 111, a conformity setting unit 312, the application unit 113, the API unit 114, an output information acquisition unit 315, and the interface unit 116. A hardware configuration of the pseudo-haptic sensation presentation device 31 will be described below.

### <Preprocessing>

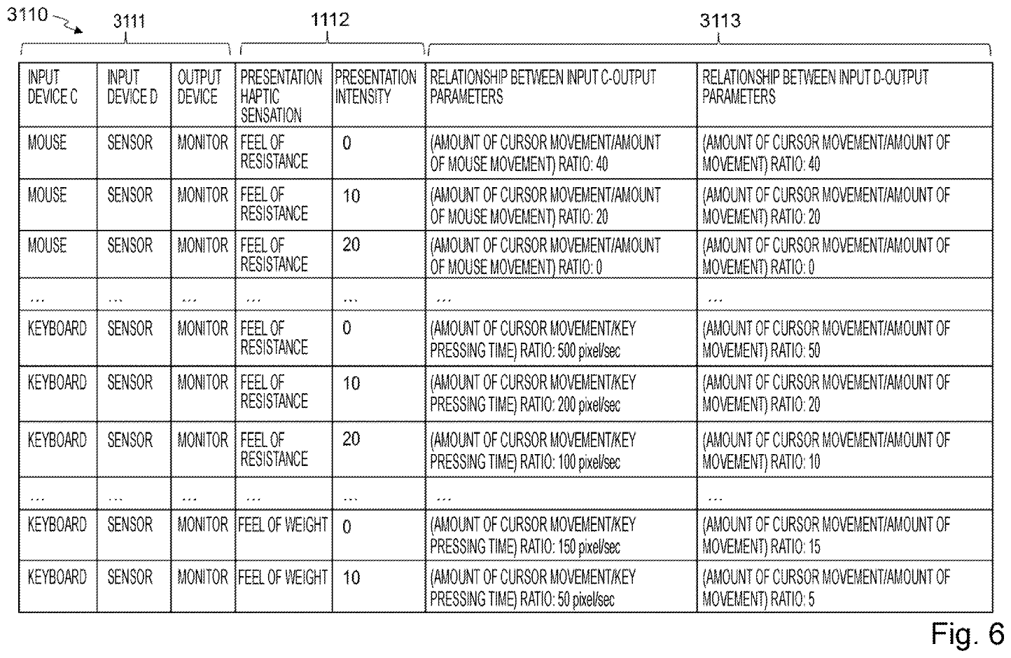

As preprocessing, correspondence information 3110 is stored in the storage unit 111. As shown in FIG. 6, the correspondence information 3110 of the present embodiment indicates a correspondence (relationship) among a plurality of pieces of registered user interface information 3111 indicating the input devices 12-1 to 12-M and the output devices 13-1 to 13-N (a plurality of different registered user interfaces; a plurality of registered user interfaces including both the input devices and the output devices), a plurality of pieces of the pseudo-haptic sensation information 1112 indicating presentation haptic sensations and presentation intensities of different pseudo-haptic sensations (contents of different pseudo-haptic sensations), and a plurality of pieces of conformity information 3113 for specifying visual information that is presented from the output devices 13-1 to 13-N in response to information input to the input devices 12-1 to 12-M in order to present a pseudo-haptic sensation (visual information that is presented from the registered user interfaces in order to present the pseudo-haptic sensation having the content indicated by the pseudo-haptic sensation information).

The correspondence information 3110 of the present embodiment is different from the correspondence information 1110 of the first embodiment in the following points. A first difference is that the correspondence information 3110 of the present embodiment includes, instead of the registered user interface information 1111, the registered user interface information 3111 that is a combination of information indicating a third registered input device (input device C) which receives third type information among the input devices 12-1 to 12-M, information indicating a fourth registered input device (input device D) which receives fourth type information different from the third type information among the input devices 12-1 to 12-M, and information indicating the output devices 13-1 to 13-N (output devices). That is, the registered user interfaces include the third registered input device that receives the third type information and the fourth registered input device that receives the fourth type information. The registered user interface information 3111 in FIG. 6 is a combination including the third registered input device (input device C, for example, mouse or keyboard) which receives the third type information, the fourth registered input device (input device D, for example, sensor) which receives the fourth type information, and the output devices 13-1 to 13-N (output devices, for example, monitors).

A second difference is that the correspondence information 3110 of the present embodiment includes, instead of the conformity information 1113, the conformity information 3113 for specifying visual information that is presented from the output devices 13-1 to 13-N (registered user interfaces; output devices, for example, monitors) in response to information including the third type information and the fourth type information input to the third registered input device (input device C, for example, mouse or keyboard) and the fourth registered input device (input device D, for example, sensor) in order to present a pseudo-haptic sensation. For example, the conformity information 3113 specifies visual information that is presented from the output devices 13-1 to 13-N (output devices, for example, monitors) in response to information (e.g. input parameters) input to the third registered input device (input device C, for example, mouse or keyboard) in order to present a pseudo-haptic sensation and visual information that is presented from the output devices 13-1 to 13-N (output devices, for example, monitors) in response to information (e.g. input parameters) input to the fourth registered input device (input device D, for example, sensor) in order to present a pseudo-haptic sensation. For example, as shown in FIG. 6, the conformity information 3113 may indicate a relationship between input C-output parameters, which is a relationship between the input parameters input to the third registered input device (input device C, for example, mouse or keyboard) and the output parameters indicating the visual information presented from the output devices 13-1 to 13-N (output devices, for example, monitors), and a relationship between input D-output parameters, which is a relationship between the input parameters input to the fourth registered input device (input device D, for example, sensor) and the output parameters indicating the visual information presented from the output devices 13-1 to 13-N (output devices, for example, monitors). The other aspects are as described above in the first embodiment.

### <Pseudo-Haptic Sensation Presentation Processing>

The following pseudo-haptic sensation presentation processing is performed on the premise of the above preprocessing, thereby presenting a pseudo-haptic sensation to the user 100.

The interface unit 116 (first input unit) receives the designation information SUI (first designation information) which designates, as the specific user interfaces used for presenting a pseudo-haptic sensation, an input device 12-m₃ (third specific input device) which receives the third type information and an input device 12-m₄ (fourth specific input device) which receives the fourth type information different from the third type information among the input devices 12-1 to 12-M and the output devices 13-1 to 13-N. That is, the specific user interfaces of the present embodiment include the third specific input device that receives the third type information and the fourth specific input device that receives the fourth type information different from the third type information. Here, m₃∈{1, . . . , M}, m₄∈{1, . . . , M}, m₃≠m₄, and n∈{1, . . . , N} are satisfied. The designation information SUI may be information (e.g. automatically detected information) indicating any input devices 12-m₃ and 12-m₄ and output device 13-n connected to the interface unit 116 or may be information input by any of the input devices 12-1 to 12-M connected to the interface unit 116. The designation information SUI input to the interface unit 116 is transmitted to the conformity setting unit 312 (step S316).

As described in the first embodiment, the application unit 113 outputs a haptic sensation presentation request including the designation information SSH. The haptic sensation presentation request including the designation information SSH is transmitted to the API unit 114. The API unit 114 transmits the haptic sensation presentation request to the conformity setting unit 312 (step S313).

The conformity setting unit 312 receives input of the designation information SUI transmitted in step S316 and the haptic sensation presentation request including the designation information SSH transmitted in step S313. The conformity setting unit 312 uses the correspondence information 3110 stored in the storage unit 111 to obtain specific conformity information that is the conformity information 3113 corresponding to the registered user interface information 3111 indicating the specific user interfaces (input devices 12-m₃ and 12-m₄ and output device 13-n) designated by the designation information SUI (first designation information) and the pseudo-haptic sensation information 1112 indicating the pseudo-haptic sensation having the content (presentation haptic sensation and presentation intensity) designated by the designation information SSH (second designation information). The specific conformity information is transmitted to the output information acquisition unit 315 (step S312).

The user 100 inputs the third type input information for presenting a pseudo-haptic sensation to the input device 12-m₃ used for presenting a pseudo-haptic sensation and inputs the fourth type input information for presenting a pseudo-haptic sensation to the input device 12-m₄. The input devices 12-m₃ and 12-m₄ receive the third type input information and the fourth type input information and transmit the input information to the interface unit 116. The interface unit 116 transmits the third type input information and the fourth type input information to the output information acquisition unit 315. The third type input information, the fourth type input information, and the specific conformity information transmitted in step S312 are input to the output information acquisition unit 315. Based on the specific conformity information, the output information acquisition unit 315 obtains and outputs third output information indicating visual information that is presented from the output device 13-n in response to the third type input information and fourth output information indicating visual information that is presented from the output device 13-n in response to the fourth type input information. The third output information and the fourth output information are input to the interface unit 116, and the interface unit 116 outputs the third output information and the fourth output information to the output device 13-n used for presenting a pseudo-haptic sensation. The output device 13-n presents the visual information (e.g. video or motion of real object) based on the third output information and the fourth output information. Therefore, the user 100 perceives a pseudo-haptic sensation requested by the haptic sensation presentation request presented from the application unit 113 (step S315).

### First Modification Example of Third Embodiment

In a case where the output devices are fixed in the third embodiment as well as in the first modification example of the first embodiment, the output devices may be omitted from the registered user interfaces, and information indicating the output devices may be omitted from the registered user interface information 3111.

### Second Modification Example of Third Embodiment

In a case where the content of the pseudo-haptic sensation to be presented is fixed in the third embodiment as well as in the first modification example of the first embodiment, the correspondence information 3110 may not include the pseudo-haptic sensation information 1112.

### Third Modification Example of Third Embodiment

The third embodiment may be combined with the second embodiment. That is, a plurality of input devices and a plurality of output devices may be used in combination to present a pseudo-haptic sensation.

### Fourth Embodiment

An input device may not be used to present a pseudo-haptic sensation.

### <Configuration>

As shown in FIG. 1, a pseudo-haptic sensation presentation system 4 of the present embodiment includes a pseudo-haptic sensation presentation device 41 for presenting a pseudo-haptic sensation based on visual information and the input device 12-1 and the output devices 13-1 to 13-N which are user interfaces for presenting the pseudo-haptic sensation based on the visual information. Here, in the present embodiment, N is an integer of 2 or more. In the present embodiment, all of the output devices 13-1 to 13-N present visual information. A hardware configuration of the pseudo-haptic sensation presentation device 41 will be described below.

### <Preprocessing>

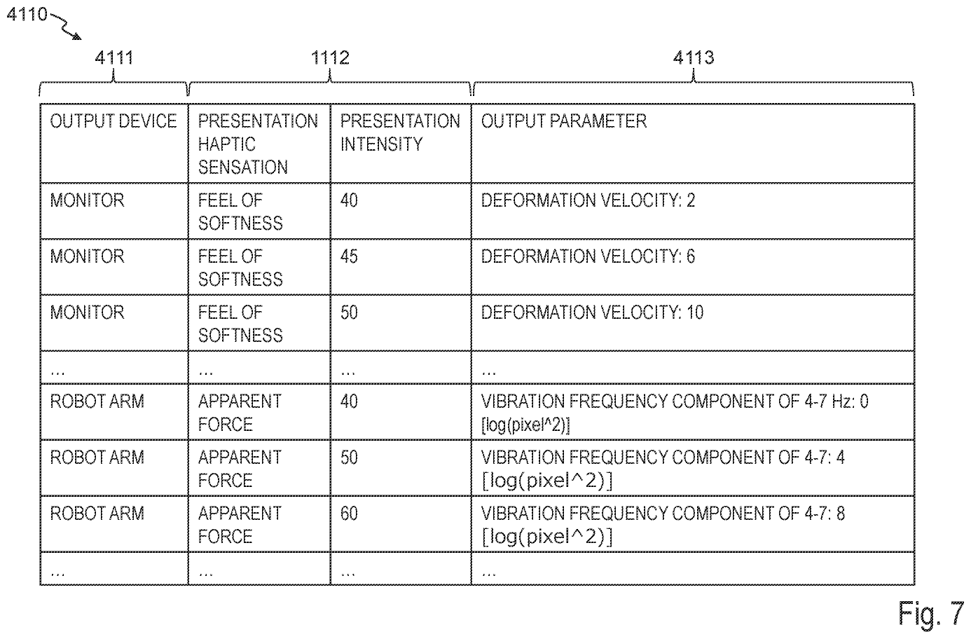

As preprocessing, correspondence information 4110 is stored in the storage unit 111. As shown in FIG. 7, the correspondence information 4110 of the present embodiment indicates a correspondence (relationship) among a plurality of pieces of registered user interface information 4111 indicating the output devices 13-1 to 13-N (a plurality of different registered user interfaces), a plurality of pieces of the pseudo-haptic sensation information 1112 indicating presentation haptic sensations and presentation intensities of different pseudo-haptic sensations (contents of different pseudo-haptic sensations), and a plurality of pieces of conformity information 4113 for specifying visual information that is presented from the output devices 13-1 to 13-N in order to present a pseudo-haptic sensation (visual information that is presented from the registered user interfaces in order to present the pseudo-haptic sensation having the content indicated by the pseudo-haptic sensation information).

The correspondence information 4110 of the present embodiment is different from the correspondence information 1110 of the first embodiment in the following points. A first difference is that the correspondence information 4110 of the present embodiment includes, instead of the registered user interface information 1111, the registered user interface information 4111 indicating the output devices 13-1 to 13-N (e.g. monitor and robot arm).

A second difference is that the correspondence information 4110 of the present embodiment includes, instead of the conformity information 1113, the plurality of pieces of the conformity information 4113 for specifying visual information that is presented from the output devices 13-1 to 13-N in order to present a pseudo-haptic sensation. The conformity information 4113 may include, for example, information for causing a human to perceive a feel of softness (pseudo-haptic sensation) which differs depending on a deformation velocity of an object to be visually presented (presentation visual target). This is based on natural law (physiological law) in which the feel of softness felt by a human who looks at the presentation visual target differs depending on the deformation velocity of the presentation visual target. In the example of FIG. 7, the conformity information 4113 includes information (output parameter) indicating the deformation velocity of the object. The conformity information 4113 may also include, for example, information for causing a second object (second presentation visual target) in contact with or in proximity to a first object (first presentation visual target) to vibrate with respect to the first object so as to include a vibration component of a specific control frequency, thereby making the second object appear as if applying an apparent force (pseudo-haptic sensation) to the first object. This is based on natural law in which the second presentation visual object can be made to appear as if applying an apparent force to the first presentation visual target (a feel of magnitude of the force can be perceived) by vibrating the second presentation visual target in contact with or in proximity to the first presentation visual object with respect to the first presentation visual object so as to include a vibration component of a specific control frequency. In the example of FIG. 7, the conformity information 4113 includes information (output parameter) indicating the magnitude of the vibration component of the control frequency of the second object (vibration frequency component [log (pixel\hat{ }2)] of 4-7 Hz).

### <Pseudo-Haptic Sensation Presentation Processing>

The following pseudo-haptic sensation presentation processing is performed on the premise of the above preprocessing, thereby presenting a pseudo-haptic sensation to the user 100.

The interface unit 116 (first input unit) receives the designation information SUI (first designation information) which designates any output device 13-n as a specific user interface used for presenting a pseudo-haptic sensation. Here, n∈{1, . . . , N} is satisfied. The designation information SUI may be information (e.g. automatically detected information) indicating any output device 13-n connected to the interface unit 116 or may be information input by any input device 12-1 connected to the interface unit 116. The designation information SUI input to the interface unit 116 is transmitted to the conformity setting unit 412 (step S416).

As described in the first embodiment, the application unit 113 outputs a haptic sensation presentation request including the designation information SSH. The haptic sensation presentation request including the designation information SSH is transmitted to the API unit 114. The API unit 114 transmits the haptic sensation presentation request to the conformity setting unit 412 (step S413).

The conformity setting unit 412 receives input of the designation information SUI transmitted in step S416 and the haptic sensation presentation request including the designation information SSH transmitted in step S413. The conformity setting unit 412 uses the correspondence information 4110 stored in the storage unit 111 to obtain specific conformity information that is the conformity information 4113 corresponding to the registered user interface information 3111 indicating the output device 13-n that is the specific user interface designated by the designation information SUI (first designation information) and the pseudo-haptic sensation information 1112 indicating the pseudo-haptic sensation having the content (presentation haptic sensation and presentation intensity) designated by the designation information SSH (second designation information). The specific conformity information is transmitted to the output information acquisition unit 415 (step S412).

The specific conformity information transmitted in step S412 is input to the output information acquisition unit 415. Based on the specific conformity information, the output information acquisition unit 415 obtains and outputs output information indicating visual information presented from the output device 13-n. The output information is input to the interface unit 116, and the interface unit 116 outputs the output information to the output device 13-n used for presenting a pseudo-haptic sensation. The output device 13-n presents the visual information (e.g. video or motion of real object) based on the output information. Therefore, the user 100 perceives a pseudo-haptic sensation requested by the haptic sensation presentation request presented from the application unit 113 (step S415).

### First Modification Example of Fourth Embodiment

In a case where the content of the pseudo-haptic sensation to be presented is fixed in the fourth embodiment as well as in the first modification example of the first embodiment, the correspondence information 4110 may not include the pseudo-haptic sensation information 1112.

### [Hardware Configuration]

Each of the pseudo-haptic sensation presentation devices 11, 21, 31, and 41 according to the embodiments is configured by a general-purpose or dedicated computer executing a predetermined program, the computer including, for example, a processor (hardware processor) such as a central processing unit (CPU) and a memory such as a random access memory (RAM) and a read only memory (ROM). That is, each of the pseudo-haptic sensation presentation devices 11, 21, 31, and 41 according to the embodiments includes, for example, processing circuitry configured to implement each unit of each pseudo-haptic sensation presentation device. The computer may include one processor and one memory or may include a plurality of processors and a plurality of memories. The program may be installed into the computer or may be recorded in a ROM or the like in advance. Some or all of processing units may be configured by using electronic circuitry that independently implements processing functions, instead of electronic circuitry that implements functional components by reading the program like a CPU. Electronic circuitry forming one device may include a plurality of CPUs.

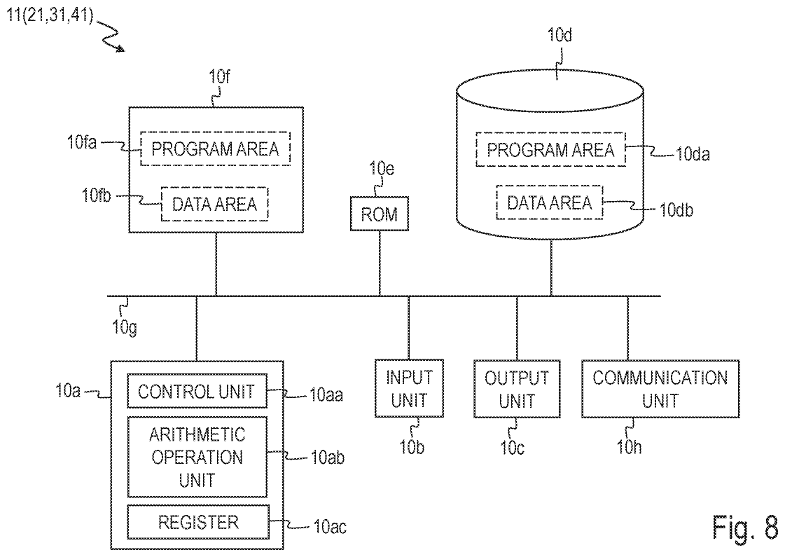

FIG. 8 is a block diagram showing a hardware configuration of each of the pseudo-haptic sensation presentation devices 11, 21, 31, and 41 according to the embodiments. As shown in FIG. 8, each of the pseudo-haptic sensation presentation devices 11, 21, 31, and 41 of this example includes a central processing unit (CPU) 10a, an input unit 10b, an output unit 10c, a random access memory (RAM) 10d, a read only memory (ROM) 10e, an auxiliary storage device 10f, a communication unit 10h, and a bus 10g. The CPU 10a of this example includes a control unit 10aa, an arithmetic operation unit 10ab, and a register 10ac and performs various arithmetic operations in accordance with various programs read into the register 10ac. The input unit 10b is an input terminal, a keyboard, a mouse, a touchscreen, or the like with which data is input. The output unit 10c is an output terminal, a display, or the like with which data is output. The communication unit 10h is a LAN card or the like controlled by the CPU 10a that has read a predetermined program. The RAM 10d is a static random-access memory (SRAM), a dynamic random-access memory (DRAM), or the like and incudes a program area 10da in which the predetermined program is stored and a data area 10db in which various kinds of data are stored. The auxiliary storage device 10f is, for example, a hard disk, a magneto-optical disc (MO), or a semiconductor memory and includes a program area 10fa in which the predetermined program is stored and a data area 10fb in which various kinds of data are stored. The bus 10g connects the CPU 10a, the input unit 10b, the output unit 10c, the RAM 10d, the ROM 10e, the communication unit 10h, and the auxiliary storage device 10f such that information can be exchanged among these components. The CPU 10a writes the program stored in the program area 10fa of the auxiliary storage device 10f into the program area 10da of the RAM 10d in accordance with a read operating system (OS) program. Similarly, the CPU 10a writes the various kinds of data stored in the data area 10fb of the auxiliary storage device 10f into the data area 10db of the RAM 10d. Addresses in the RAM 10d into which the program and the data have been written are stored in the register 10ac of the CPU 10a. The control unit 10aa of the CPU 10a sequentially reads the addresses stored in the register 10ac, reads the program and the data from the areas in the RAM 10d indicated by the read addresses, causes the arithmetic operation unit 10ab to sequentially perform arithmetic operations indicated by the program, and stores results of the arithmetic operations in the register 10ac. Such a configuration implements the functional components of the pseudo-haptic sensation presentation devices 11, 21, 31, and 41.

The above program can be recorded in a computer-readable recording medium. Examples of the computer-readable recording medium include a non-transitory recording medium. Examples of such a recording medium include a magnetic recording device, an optical disc, a magneto-optical recording medium, and a semiconductor memory.

The program is distributed by selling, giving, or renting a portable recording medium such as a DVD or CD-ROM recording the program thereon, for example. The program may also be distributed by being stored in a storage device of a server computer and being transferred from the server computer to other computers via a network. As described above, such a computer executing the program first temporarily stores the program recorded in the portable recording medium or the program transferred from the server computer in a storage device of the computer, for example. When performing processing, the computer reads the program stored in the storage device of the computer and performs processing in accordance with the read program. In other modes of performing the program, the computer may read the program directly from the portable recording medium and performs processing in accordance with the program, or alternatively, the computer may sequentially perform processing in accordance with the received program every time the program is transferred from the server computer to the computer. The above processing may also be performed by a so-called application service provider (ASP) service that implements a processing function only by an execution instruction and acquisition of the result, without transferring the program from the server computer to the computer. The program according to the present embodiment includes information used for processing by an electronic computer and equivalent to the program (e.g. data that is not a direct instruction to the computer but has a property that defines the processing of the computer).

Although the present device is configured by executing a predetermined program in the computer in each embodiment, at least part of processing content may be implemented by hardware.

### Other Modification Examples

The present invention is not limited to the above embodiments. For example, in order to cause different users (e.g. user 100 of FIG. 1 and user 101′) to perceive a pseudo-haptic sensation having the same or substantially the same content by using a plurality of different specific user interfaces (a first specific user interface and a second user interface different from the first specific user interface), the pseudo-haptic sensation presentation processing in any one of the first to fourth embodiments or the modification examples thereof may be performed a plurality of times, or a plurality of kinds of the pseudo-haptic sensation presentation processing may be performed in parallel. That is, in order to cause the user 100 and the user 100′ different from each other to perceive the same or substantially the same pseudo-haptic sensation, pseudo-haptic sensation presentation processing (first processing) in which the first specific user interface used by the user 100 is the specific user interface and pseudo-haptic sensation presentation processing (second processing) in which the second specific user interface used by the user 100′ is the specific user interface may be performed in series or in parallel. In other words, the conformity setting unit and the output information acquisition unit may perform the first processing performed by using the first specific user interface as the specific user interface and the second processing performed by using the second specific user interface different from the first specific user interface as the specific user interface. Here, a pseudo-haptic sensation presented by presenting, from the first specific user interface, visual information indicated by output information obtained in the first processing is the same or substantially the same as a pseudo-haptic sensation presented by presenting, from the second specific user interface, visual information indicated by output information obtained in the second processing.

The above various kinds of processing may be performed not only in a chronological manner in accordance with the description but also in parallel or individually in accordance with the processing ability of the device that performs the processing or as necessary. In addition, it is needless to say that appropriate modifications can be made without departing from the scope of the present invention.

### REFERENCE SIGNS LIST

1, 2, 3, 4 Pseudo-haptic sensation presentation system
11, 21, 31, 41 Pseudo-haptic sensation presentation device
112, 212, 312, 412 Conformity setting unit
115, 215, 315, 415 Output information acquisition unit

1. A pseudo-haptic sensation presentation device for presenting a pseudo-haptic sensation based on visual information, the pseudo-haptic sensation presentation device comprising processing circuitry configured to:
receives receive first designation information that designates a specific user interface used for presenting a pseudo-haptic sensation;
by using correspondence information indicating a correspondence between a plurality of pieces of registered user interface information indicating a plurality of different registered user interfaces and a plurality of pieces of conformity information for specifying visual information that is presented from the registered user interfaces in order to present the pseudo-haptic sensation, obtain specific conformity information that is conformity information corresponding to the registered user interface information indicating the specific user interface designated by the first designation information; and
based on the specific conformity information, obtain output information indicating visual information that is presented from the specific user interface.

2. The pseudo-haptic sensation presentation device according to claim 1, wherein
the specific user interface includes at least one of a specific input device or a specific output device,
the plurality of registered user interfaces includes at least one of a plurality of different input devices or a plurality of different output devices,
the plurality of pieces of the registered user interface information indicates at least one of the plurality of input devices or the plurality of output devices,
the plurality of pieces of the conformity information specifies visual information that is presented from the output device in response to information input to the input device in order to present the pseudo-haptic sensation, and
the output information indicates visual information that is presented from the specific output device in response to information input to the specific input device.

3. The pseudo-haptic sensation presentation device according to claim 1, wherein the processing circuitry is configured to further
receive second designation information that designates a content of the pseudo-haptic sensation to be presented, wherein
the correspondence information indicates a correspondence among the plurality of pieces of the registered user interface information, a plurality of pieces of pseudo-haptic sensation information indicating contents of different pseudo-haptic sensations, and the plurality of pieces of the conformity information for specifying the visual information that is presented from the registered user interfaces in order to present the pseudo-haptic sensation having the content indicated by the pseudo-haptic sensation information, and
the processing circuitry is configured to use the correspondence information
to obtain the specific conformity information that is conformity information corresponding to
the registered user interface information indicating the specific user interface designated by the first designation information and the pseudo-haptic sensation information indicating the pseudo-haptic sensation having the content designated by the second designation information.

4. The pseudo-haptic sensation presentation device according to claim 1, wherein
the specific user interface includes a first specific output device that presents first type visual information and a second specific output device that presents second type information different from the first type visual information,
the plurality of registered user interfaces includes a first registered output device that presents the first type visual information and a second registered output device that presents the second type information, and
the plurality of pieces of the conformity information specifies the first type visual information and the second type information presented from the first registered output device and the second registered output device in order to present the pseudo-haptic sensation.

5. The pseudo-haptic sensation presentation device according to claim 1, wherein
the specific user interface includes a third specific input device that receives third type information and a fourth specific input device that receives fourth type information different from the third type information,
the plurality of registered user interfaces includes a third registered input device that receives the third type information and a fourth registered input device that receives the fourth type information, and
the plurality of pieces of the conformity information specifies the visual information that is presented from the registered user interfaces in response to information including the third type information and the fourth type information input to the third registered input device and the fourth registered input device in order to present the pseudo-haptic sensation.

6. The pseudo-haptic sensation presentation device according to claim 1, wherein
the processing circuitry is configured to perform first processing performed by using a first specific user interface as the specific user interface and second processing performed by using a second specific user interface different from the first specific user interface as the specific user interface, and
a pseudo-haptic sensation presented by presenting the visual information indicated by the output information obtained by the first processing from the first specific user interface is the same as or substantially the same as a pseudo-haptic sensation presented by presenting the visual information indicated by the output information obtained by the second processing from the second specific user interface.

7. A pseudo-haptic sensation presentation method performed by a pseudo-haptic sensation presentation device for presenting a pseudo-haptic sensation based on visual information, the pseudo-haptic sensation presentation method comprising:
receiving first designation information that designates a specific user interface used for presenting a pseudo-haptic sensation;
by using correspondence information indicating a correspondence between a plurality of pieces of registered user interface information indicating a plurality of different registered user interfaces and a plurality of pieces of conformity information for specifying visual information that is presented from the registered user interfaces in order to present the pseudo-haptic sensation, obtaining specific conformity information that is conformity information corresponding to the registered user interface information indicating the specific user interface designated by the first designation information; and
based on the specific conformity information, obtaining output information indicating visual information that is presented from the specific user interface.

8. A non-transitory computer-readable recording medium storing program for causing a computer to function as the pseudo-haptic sensation presentation device according to claim 1.
